(19) United States
(12) Patent Application Publication
(10) Pub. No.: US 2021/0311332 A1
(43) Pub. Date: Oct. 7, 2021

(54) Eyeglasses For Providing Variable Focuses, To Which Attachable/Detachable Module Is Coupled

(71) Applicants: Min Ho LEE, Gyeonggi-do (KR); ESHEL CO., LTD., Incheon (KR)

(72) Inventor: Min Ho LEE, Gyeonggi-do (KR)

(73) Assignees: Min Ho LEE, Gyeonggi-do (KR); ESHEL CO., LTD., Incheon (KR)

(21) Appl. No.: 17/263,032

(22) PCT Filed: May 17, 2019
(86) PCT No.: PCT/KR2019/005893

§ 371 Date: Jan. 25, 2021

(30) Foreign Application Priority Data
Jul. 25, 2018 (KR) 10-2018-0086324

(51) Int. Cl. G02C 9/00; G02C 11/00; G02C 7/06

(52) U.S. Cl. CPC G02C 9/00; G02C 7/06; G02C 11/10

(57) ABSTRACT

According to several exemplary embodiments of the present disclosure, eyeglasses providing varifocal focus are disclosed. Eyeglasses for providing varifocal focus according to several exemplary embodiments of the present disclosure include: a power supply unit; a first lens and a second lens receiving a voltage from the power supply unit, and providing varifocal focus; a first frame coupled with the first lens and the second lens, and having a shape to be worn by a user; and a detachable module being detachable to the first frame, in which the detachable module comprises a bone conduction module receiving AC signals from the power supply unit by being attached to the first frame.

### CROSS-REFERENCE TO RELATED APPLICATIONS

This application claims priority to and the benefit of Korean Patent Application No. 10-2018-0086324 filed in the Korean Intellectual Property Office on Jul. 25, 2018, the entire contents of which are incorporated herein by reference

### TECHNICAL FIELD

The present disclosure relates to eyeglasses for providing varifocal focus, and particularly, provides various functions to eyeglasses providing varifocal focus in which a bone conduction module and a display module are attached/detached in a form of one module.

### BACKGROUND ART

Presbyopia refers to a gradual decline in the control function of the lens around the age of 40 or 45. The elasticity of the lens is decreased or the lens is enlarged, so that the range of near visual life is reduced which makes it difficult for a person to see objects located at a close range. Therefore, the person will feel tired when reading or at rest.

General lenses used for vision correction includes one or more fixed focus adjustment magnification. For example, people with symptoms of presbyopia, in which the lens of the eye loses elasticity and near-distance focus adjustments are impaired, use an ophthalmic device that provides different fixed magnifications for near and far vision. The lenses with fixed focus adjustment magnification limit the lens' vision correction possibility to standard magnification and position within the lens.

For vision correction, single vision lenses, bifocal lenses, multifocal lenses, and the like are used. The single vision lens is a lens that corrects a vision for a short or long distance, and it is inconvenient for a user to change and wear eyeglasses to correspond to each distance. The bifocal lenses may correct visions for both long and short distances. The bifocal lenses vary a refractive index of a specific area of the lens, so that a wearer may see near and far distances depending on the position of the wearer's gaze, but the peripheral part of the gaze is not corrected, so that the wearer may feel tired easily, needs to adjust a location of the gaze, or and has inconvenience in changing and wearing the eyeglasses. Further, the wearer wearing the bifocal lenses may accompany dizziness when going down stairs or looking at a distance and looking closer, and an image jump phenomenon may appear, and the bifocal lenses has a problem in appearance due to the boundary between the part for a near distance and the part for a far distance. The multifocal lens is a lens including a portion for near distance, a progressive portion, and a portion for far distance, and has less image jump or dizziness than a bifocal lens, and enables a wearer to see near, intermediate, and long distances with continuous refractive index change from far to near. However, the multifocal lens has a narrow lens area with multiple power, so that the areas of the progressive portion and the portion for near distance are small, and due to distortion and astigmatism in the lateral portion of the progressive zone, image blur or shake is more severe than that of a bifocal lens at the lateral side, and since the progressive band used for clearly seeing the intermediate distance is narrow and unstable, it is impossible to stably use the multifocal lens for a long time and the field of view of the portion for near distance is narrow, so that the multifocal lens is inconvenient.

Accordingly, in order to solve the problems, there may be a demand in the art for eyeglasses provided with a refractive index variable lens.

In the meantime, recently, as Head Mounted Display (HMD) devices have been lightened, users may wear the HMD devices like eyeglasses. However, in the case of the user wearing the eyeglasses provided with the refractive index variable lens, in order to wear the HMD device providing sound, the user needs to inconveniently take off his/her eyeglasses and wear the HMD device.

In the meantime, recently, products using bone conduction technology, which have become widely known as being installed in mobile phones, are appearing one after another. Various electronic devices, for example, application products, such as speakers or hearing aids, using bone conduction technology are commercially available.

In the meantime, when a user who wears eyeglasses wears a bone conduction earphone together with the eyeglasses, the bone conduction earphone is placed on the frame of the eyeglasses, which is inconvenient to the user.

Accordingly, in order to solve the problems, there may be a demand in the art for an HMD device detachable from eyeglasses providing varifocal focus.

The prior art literature includes Korean Patent Application Laid-Open No. 10-2012-0080852 and Korean Patent Nos. 10-2012-0080852 and 10-0934390.

### SUMMARY OF THE INVENTION

The present disclosure is conceived in response to the background art, and has been made in an effort to provide eyeglasses providing varifocal focus in which a bone conduction module and a display module are attached to and detached from the eyeglasses in a form of one module.

According to several exemplary embodiments of the present disclosure, a bone conduction module and a display module may receive common power through eyeglasses providing varifocal focus in a form of one module.

The technical objects of the present disclosure are not limited to the foregoing technical objects, and other non-mentioned technical objects will be clearly understood by those skilled in the art from the description below.

An exemplary embodiment of the present disclosure provides eyeglasses for providing varifocal focus, including: a power supply unit; a first lens and a second lens receiving a voltage from the power supply unit, and providing varifocal focus; a first frame coupled with the first lens and the second lens, and having a shape to be worn by a user; and a detachable module being detachable to the first frame, in which the detachable module comprises a bone conduction module receiving AC signals from the power supply unit by being attached to the first frame.

The technical solutions obtainable from the present disclosure are not limited to the foregoing solutions, and other non-mentioned solution means will be clearly understood by those skilled in the art from the description below.

According to several exemplary embodiments of the present disclosure, a bone conduction module and a display module may be attached to and detached from eyeglasses providing varifocal focus in a form of one module.

The effects of the present disclosure are not limited to the foregoing effects, and other non-mentioned effects will be clearly understood by those skilled in the art from the description below.

### BRIEF DESCRIPTION OF THE DRAWINGS

Various aspects are described with reference to the drawings, and herein, like reference numerals are generally used to designate like constituent elements. In the exemplary embodiment below, for the purpose of description, a plurality of specific and detailed matters is suggested in order to provide general understanding of one or more aspects. However, it is apparent that the aspect(s) may be carried out without the specific and detailed matters.

FIG. 1 is a block diagram illustrating eyeglasses providing varifocal focus according to several exemplary embodiments.

FIG. 2 is a lateral cross-sectional view of a lens of the eyeglasses providing varifocal focus according to several exemplary embodiments.

FIG. 3 is a diagram illustrating an example of the eyeglasses providing varifocal focus to which a detachable module is attached according to several exemplary embodiments.

FIG. 4 is a diagram for describing an example of a method of attaching the detachable module to the eyeglasses providing varifocal focus according to several exemplary embodiments.

FIG. 5 is a flowchart illustrating an example of a method of supplying a predetermined voltage to a first lens in the case where the detachable module is attached to a first frame according to several exemplary embodiments of the present disclosure.

FIG. 6 is a diagram illustrating an example of an exterior appearance of a bone conduction module included in the detachable module according to several exemplary embodiments of the present disclosure.

FIG. 7 is a cross-sectional view of the bone conduction module taken along line A-A′ of FIG. 6.

FIG. 8 is an enlarged view of one region of an upper surface of the bone conduction module included in the detachable module according to several exemplary embodiments of the present disclosure.

FIG. 9 is a diagram illustrating an example of the case where a user wears the eyeglasses providing varifocal focus to which the detachable module is attached according to several exemplary embodiments.

### DETAILED DESCRIPTION

Various exemplary embodiments and/or aspects are now disclosed with reference to the drawings. In the description below, the plurality of particular detailed matters are disclosed for helping general understanding of one or more aspects for the purpose of description. However, the point that the aspect(s) is executable even without the particular detailed matters may also be recognized by those skilled in the art. The subsequent description and the accompanying drawings describe specific illustrative aspects of one or more aspects in detail. However, the aspects are illustrative, and some of the various methods of various aspects of the principles may be used, and the descriptions intend to include all of the aspects and the equivalents thereof. An “exemplary embodiment”, an “example”, an “aspect”, an “illustration”, and the like used in the present specification may not be construed to be better or have an advantage compared to a predetermined described aspect, an aspect having a different design, or designs.

Hereinafter, the same or similar constituent element is denoted by the same reference numeral regardless of a reference numeral, and a repeated description thereof will be omitted. Further, in describing the exemplary embodiment disclosed in the present disclosure, when it is determined that a detailed description relating to well-known functions or configurations may make the subject matter of the exemplary embodiment disclosed in the present disclosure unnecessarily ambiguous, the detailed description will be omitted. Further, the accompanying drawings are provided for helping to easily understand exemplary embodiments disclosed in the present specification, and the technical spirit disclosed in the present specification is not limited by the accompanying drawings.

A term used in the present specification is for describing the exemplary embodiments, and does not intend to limit the present disclosure. In the present specification, a singular form includes a plural form as well, unless otherwise mentioned. A term “comprises” and/or “comprising” used in the specification do not exclude the existence or an addition of one or more other constituent elements, in addition to the mentioned constituent element.

Although “a first”, “a second”, and the like are used for describing various elements or constituent elements, but the elements or the constituent elements are not limited by the terms. The terms are used for discriminating one element or constituent element from another element or constituent element. Accordingly, a first element or constituent element mentioned below may also be a second element or constituent element within the technical spirit of the present disclosure as a matter of course.

Unless otherwise defined, all of the terms (including technical and scientific terms) used in the present specification may be used as a meaning commonly understandable by those skilled in the art. Further, terms defined in a generally used dictionary shall not be construed as being ideal or excessive in meaning unless they are clearly defined.

A term “or” intends to mean comprehensive “or”, not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present specification shall be understood to designate and include all of the possible combinations of one or more items among the listed relevant items.

A term “include” and/or “including” shall be understood as meaning that a corresponding characteristic and/or a constituent element exists, but it shall be understood that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Terms “information” and “data” used in the present specification may be frequently used to be exchangeable with each other.

Hereinafter, the same or similar constituent element is denoted by the same reference numeral regardless of a reference numeral, and a repeated description thereof will be omitted. Further, in describing the exemplary embodiment disclosed in the present disclosure, when it is determined that detailed description relating to well-known functions or configurations may make the subject matter of the exemplary embodiment disclosed in the present disclosure unnecessarily ambiguous, the detailed description will be omitted. Further, the accompanying drawings are provided for helping to easily understand exemplary embodiments disclosed in the present specification, and the technical spirit disclosed in the present specification is not limited by the accompanying drawings.

Although “a first”, “a second”, and the like are used for describing various elements or constituent elements, but the elements or the constituent elements are not limited by the terms. The terms are used for discriminating one element or constituent element from another element or constituent element. Accordingly, a first element or constituent element mentioned below may also be a second element or constituent element within the technical spirit of the present disclosure as a matter of course.

Unless otherwise defined, all of the terms (including technical and scientific terms) used in the present specification may be used as a meaning commonly understandable by those skilled in the art. Further, terms defined in a generally used dictionary shall not be construed as being ideal or excessive in meaning unless they are clearly defined.

It should be understood that when one constituent element referred to as being “coupled to” or “connected to” another constituent element, one constituent element can be directly coupled to or connected to the other constituent element, but intervening elements may also be present. In contrast, when one constituent element is “directly coupled to” or “directly connected to” another constituent element, it should be understood that there are no intervening element present.

Suffixes, “module” and “unit” for a constituent element used for the description below are given or mixed in consideration of only easiness of the writing of the specification, and the suffix itself does not have a discriminated meaning or role.

When an element or a layer is referred to as being “on” another element or layer, the element or the layer may be directly formed on another element or layer, or may be formed on another element or layer with another layer or element interposed therebetween. In contrast, when an element is referred to as being “directly on” another element, there are no intervening element or layer present.

The spatially relative terms, “below, “beneath”, “lower”, “above”, “upper”, and the like may be used for easily describing the correlation of one element with other elements as illustrated in the drawings. The spatially relative terms should be understood as the terms including different directions of the elements when the elements are used or operated in addition to the direction illustrated in the drawing.

For example, when an element illustrated in the drawing is turned over, the element described as being “below or beneath” the other element may be placed “above” the other element. Accordingly, the illustrative term “below or beneath” may include both the directions below and above. The element may also be oriented in different directions, and in this case, the spatially relative terms may be interpreted according to the orientation.

An object and effect of the present disclosure and technical configurations for achieving them will be apparent with reference to the exemplary embodiments described below in detail together with the accompanying drawings. In describing the present disclosure, when it is determined that detailed description of known function or configurations unnecessarily obscures the subject matter of the present disclosure, the detailed description may be omitted. Further, the terms used in the description are defined in consideration of the function in the present disclosure and may vary depending on an intention or usual practice of a user or operator.

However, the present disclosure is no limited to the exemplary embodiments disclosed below, but may be implemented in various different forms. However, the present exemplary embodiments are provided only to make the present disclosure complete, and to fully inform the scope of the disclosure to those skilled in the art, and the present disclosure is only defined by the scope of the claims. Accordingly, the definition should be made based on the content throughout the present specification.

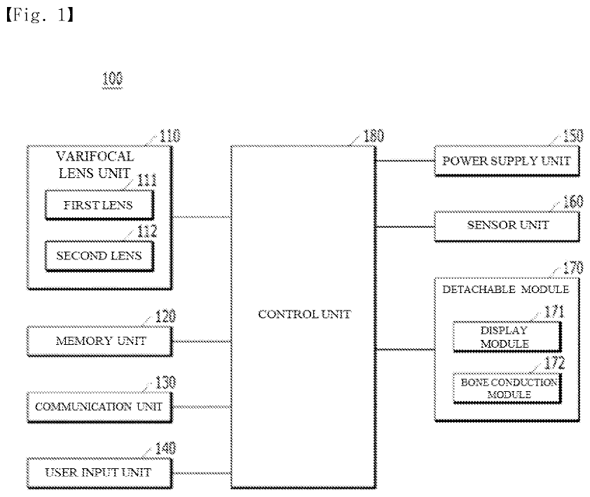

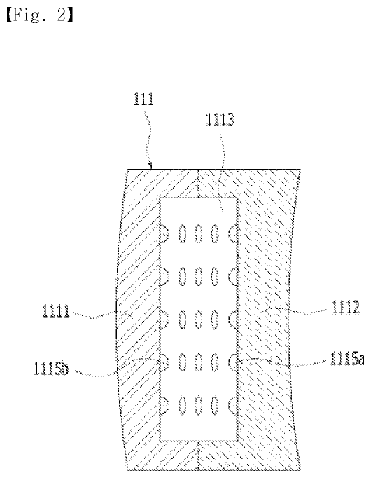

FIG. 1 is a block diagram illustrating eyeglasses providing varifocal focus according to several exemplary embodiments. FIG. 2 is a lateral cross-sectional view of a lens of the eyeglasses providing varifocal focus according to several exemplary embodiments.

Referring to FIG. 1, eyeglasses 100 for providing varifocal focus may include a varifocal lens unit 110, a memory unit 120, a communication unit 130, a user input unit 140, a power supply unit 150, a sensor unit 160, a detachable module 170, and a control unit 180. However, the foregoing constituent elements are not essential for implementing the eyeglasses 100 for providing varifocal focus, so that the eyeglasses 100 for providing varifocal focus may include more or less constituent elements than the foregoing listed constituent elements. Herein, each of the constituent elements may be formed of a separate chip, module, or device, and may also be included in one device.

The varifocal lens unit 110 may include a first lens 111 and a second lens 112 which receives voltage through the power supply unit 150 and provide varifocal focus. However, the present disclosure is not limited thereto.

Referring to FIG. 2, the first lens 111 may include a first lens-shape optical unit 1111, a second lens-shape optical unit 1112, a liquid crystal layer 1113, a display unit 1114, at least one transparent electrode 1115a and 1115b, and a nano-structure (not illustrated). However, the foregoing constituent elements are not essential for implementing the first lens 111, so that the first lens 111 may include more or less constituent elements than the foregoing listed constituent elements.

The first lens-shape optical unit 1111 and the second lens-shape optical unit 1112 may be disposed so that one side of each of the first lens-shape optical unit 1111 and the second lens-shape optical unit 1112 is in contact with the liquid crystal layer 1113. The first lens 111 may have the structure in which the first lens-shape optical unit 1111 and the second lens-shape optical unit 1112 accommodate the liquid crystal layer 1113.

The first lens-shape optical unit 1111 and the second lens-shape optical unit 1112 may be formed of at least one of a concave lens, a convex lens, and an aspherical lens. Further, the foregoing kind of lens is merely an example, and the first lens-shape optical unit 1111 and the second lens-shape optical unit 1112 may be formed of a predetermined shape of lens.

In the first lens 111 according to several exemplary embodiments, the first transparent electrode 1115a and the second transparent electrode 1115b may be positioned at one side of the first lens-shape optical unit 1111 and one side of the second lens-shape optical unit 1112, respectively.

However, the present disclosure is not limited thereto, and the transparent electrode may also be positioned at one side of the first lens-shape optical unit 1111 or the second lens-shape optical unit 1112 so as to be in contact with one side of the liquid crystal layer 1113.

In the meantime, the liquid crystal layer 1113 may be accommodated inside the first lens-shape optical unit 1111 or the second lens-shape optical unit 1112. The liquid crystal layer 1113 allows a refractive index of light passing through the liquid crystal layer 1113 to be changed based on an arrangement state of the liquid crystal layer 1113 which is changed by a voltage applied from the first transparent electrode 1115a and the second transparent electrode 1115b to the liquid crystal layer 1113, thereby enabling the focus of the first lens 111 to be variable. Accordingly, the eyeglasses according to the several exemplary embodiments of the present disclosure may provide varifocal focus, so that the user is not affected by the appearance and may be used conveniently without the bothersome need to change eyeglasses. The voltage applied to the liquid crystal layer 1113 by the closed curves of the first transparent electrode 1115a and the second transparent electrode 1115b may be adjusted so that a deviation between the refractive index of the liquid crystal layer 1113 and the refractive indexes of the first lens-shape optical unit 1111 and the second lens-shape optical unit 1112 increases from a center portion of the first lens 111 to an outer periphery of the first lens 111. The liquid crystal layer 1113 may have the refractive index that is the same as or similar to that of the first lens-shape optical unit 1111 and the second lens-shape optical unit 1112 in the center portion of the first lens 111, but may have the refractive index having the large deviation from the refractive indexes of the first lens-shape optical unit 1111 and the second lens-shape optical unit 1112 in the outer periphery of the first lens 111.

The liquid crystal layer 1113 may be formed of a plurality of regions, and the voltage applied to the liquid crystal layer 1113 may be differently adjusted according to the plurality of regions so as to suppress aberration by varying the refractive index of the liquid crystal layer according to the position in the first lens 111. The refractive indexes of the first lens-shape optical unit 1111 and the second lens-shape optical unit 1112 according to the positions in the first lens 111 are uniform, but the refractive index of the liquid crystal layer 1113 may be different in the refractive index between the center portion and the outer periphery of the first lens 111.

The liquid crystal layer 1113 may include at least one of nematic liquid crystal, smectic liquid crystal, ferroelectric liquid crystal, and chiral liquid crystal. Further, the liquid crystal layer 1113 may include different types of liquid crystals to enable fine diopter adjustment.

The first transparent electrode 1115a may be formed of one or more closed curves so as to apply a voltage to the liquid crystal layer 1113 according to the position in the first lens 111, and may be positioned at one side of the first lens-shape optical unit 1111 so as to apply the voltage to the liquid crystal layer 1113 in a vertical direction together with the second transparent electrode 1115b. Further, the first transparent electrode 1115a may be formed of one or more closed curves so as to apply a voltage to the liquid crystal layer 1113 according to the position in the first lens 111, and may be positioned at one side of the second lens-shape optical unit 1111 so as to apply the voltage to the liquid crystal layer 1113 in a vertical direction together with the first transparent electrode 1115a. The first transparent electrode 1115a and the second transparent electrode 1115b may be formed of one or more closed curves so as to apply a voltage to the liquid crystal layer 1113 according to the position in the first lens 111, and may be formed of a material which enables light to pass and has electric conductivity.

The nano-structure (not illustrated) is a structure in the form of a moth eye, and may be positioned in one side of the first lens-shape optical unit 1111 or one side surface of the second lens-shape optical unit 1112. The nano-structure may increase a change in a refractive index by the liquid crystal layer 1113. Further, the nano-structure may reduce reflection of light to enable the user of the eyeglasses 100 to more clearly view the object. The nano-structure may reduce reflection of light to maximize a change in a refractive index by the liquid crystal layer 1113 and decrease a thickness of the liquid crystal layer 1113. Accordingly, the overall thickness of the first lens 111 may be properly configured without being too thick, so that it is possible to provide the user with the eyeglasses 100 with a better appearance.

A part of the liquid crystal layer 1113 may include a display unit (not illustrated) which blocks at least a part of light passing through the liquid crystal layer 1113 and may display information that may be recognized by the user of the first lens 111. The display unit 114 may display visual information in a part of the first lens 111 by blocking at least a part of the light passing through the first lens 111 by distortion of the liquid crystal particles of the liquid crystal layer 1113.

In relation to FIG. 2, the description has been given only for the first lens 111, but the foregoing description may be applied equally to the second lens 112.

In the meantime, referring back to FIG. 1, the first lens 111 and the second lens 112 included in the varifocal lens unit 110 may receive a voltage from the power supply unit 150 and provide varifocal focus. In this case, the control unit 180 may change a size of the voltage provided to the first lens 111 and the second lens 112 and change focus.

The method of providing varifocal focus by receiving voltage by the first lens 111 and the second lens 1112 included in the varifocal lens unit 110 is discussed in detail in Korean Patent Application No. 10-2015-0100084 (filed on Jul. 14, 2015) of which the entirety is incorporate in the present application as a reference.

The memory unit 120 stores data supporting various functions of the eyeglasses 100 for providing varifocal focus. The memory unit 120 may store a plurality of application programs (or applications) driven in the eyeglasses 100 for providing varifocal focus, data for an operation of the eyeglasses 100 for providing varifocal focus, and commands. At least a part of the application programs may be downloaded from an external server through wireless communication. Further, at least a part of the application program may exist in the eyeglasses 100 for providing varifocal focus from the time of release for the basic function (for example, the function of controlling a size of the voltage applied to the liquid crystal layer) of the eyeglasses 100 for providing varifocal focus. In the meantime, the application program is stored in the memory unit 120 and is installed in the eyeglasses 100 for providing varifocal focus, and is driven by the control unit 180 so as to perform the operation (or the function) of the eyeglasses 100 for providing varifocal focus.

According to several exemplary embodiments, the memory unit 120 may record at least one of a voltage applied to the liquid crystal layer, the amount of distortion of the liquid crystal layer, an orientation, a type of the liquid crystal layer, a refractive index of light passing through the liquid crystal layer, a focal length of the lens based on the state of the liquid crystal layer, and user's eyesight of the lens. The recorded information may be used for implementing a database including a distance between the eyesight of the user and the target, a size of the voltage for correcting the distance, and the like.

The memory unit 120 may store data and commands for the operation of the detachable module 170 when the detachable module 170 is attached to the eyeglasses 100 for providing varifocal focus.

According to several exemplary embodiments, the visual information displayed in the display module 171 included in the detachable module 170 may be stored in the memory unit 120. Further, information about a vibration signal output by the bone conduction module 172 may be stored in the memory unit 120.

The communication unit 130 may communicate with an external computing device through wired/wireless communication. As wireless Internet technology, a Wireless LAN (WLAN) (Wi-Fi), a Wireless broadband (Wibro), World Interoperability for Microwave Access (Wimax), High Speed Downlink Packet Access (HSDPA), and the like may be used. As wired Internet technology, Digital Subscriber Line (XDSL), Fibers to the home (FTTH), Power Line Communication (PLC), and the like may be used.

The communication unit 130 may include a short-range communication module to transceive data with an external computing device which is located relatively close to the eyeglasses 100 for providing varifocal focus and includes a short-range communication module. As short range communication technology, Bluetooth, Radio Frequency Identification (RFID), Infrared Data Association (IrDA), Ultra Wideband (UWB), ZigBee, and the like may be used.

The communication unit 130 may include a communication means, such as a Universal Serial Bus (USB), thunderbolt, SATA, mSATA, PCI, and the like. The external computing device and a user terminal may include a Personal Computer (PC), a notebook computer, a mobile terminal, a smart phone, a tablet PC, a main frame computer, a middle-sized computer, a large computer, a server, and the like, and may include all kinds of terminals which are capable of accessing a wired/wireless network.

According to several exemplary embodiments, the communication unit 130 may transmit the data recorded in the memory unit 120 to the external computing device so as for the external computing device to generate a database related to eyesight correction.

The user input unit 140 receives an input of information from the user, and when the information is input through the user input unit 140, the control unit 180 may control the operation of the eyeglasses 100 for providing varifocal focus so as to correspond to the input information. The user input unit 140 may include a mechanical input means (or a mechanical key, for example, a button, a dome switch, a jog wheel, and a jog switch) and a touch-type input means.

The user input unit 140 may allow the user to adjust the voltage applied to the liquid crystal. As the control unit 180 receives the input of the user through the user input unit 140, the control unit 180 may control the voltage to be applied to the liquid crystal according to a distance from the target to be viewed by the user.

The user input unit 140 may be disposed in one region of a first frame of the eyeglasses 100 for providing varifocal focus.

The user may change an operation mode of the eyeglasses 100 for providing varifocal focus to a long-range mode, a medium-range mode, or a short-range mode by using the user input unit 140. In particular, the control unit 180 may change the operation mode of the eyeglasses 100 for providing varifocal focus to a long-range mode, a medium-range mode, or a short-range mode according to the reception of the input of the user through the user input unit 140.

The user may make the focus of the glasses be continuously changed or be discontinuously changed according to a predetermined mode through the user input unit 140.

The power supply unit 150 may receive inner power and supply the power to each constituent element included in the eyeglasses 100 for providing varifocal focus under the control of the control unit 180. The power supply unit 150 includes a battery, and the battery may be an embedded battery or a replaceable battery.

The power supply unit 150 may include a connection port, and the connection port may be configured as an example of an interface to which an external charger supplying power for charging the battery is electrically connected.

As another example, the power supply unit 150 may be configured so as to wirelessly charge the battery without using the connection port. In this case, the power supply unit 150 may receive power from an external wireless power transmission device by using one or more of an inductive coupling method based on a magnetic induction phenomenon or a magnetic resonance coupling method based on an electromagnetic resonance phenomenon.

Herein, the power supply unit 150 is a chargeable battery, and may be any one selected from a nickel cadmium battery, a nickel hydride battery, and a Li-ion battery, but the scope of the present disclosure is not limited thereto.

The sensor unit 160 may include one or more sensors for sensing at least one of information inside the eyeglasses 100 for providing varifocal focus, surrounding environment information around the eyeglasses 100 for providing varifocal focus, and user information. For example, the sensor unit 160 may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor, a microphone, a battery gauge, an environment sensor (for example, a barometer, a hydrometer, a thermometer, a radiation detection sensor, a heat detection sensor, and a gas detection sensor), and a chemical sensor (for example, an electronic nose, a healthcare sensor, and a biometric sensor). In the meantime, the eyeglasses 100 for providing varifocal focus disclose in the present specification may combine information sensed by two or more sensors among the sensors and utilize the combined information.

The representative sensors among various sensors includable in the sensor unit 160 will be described in more detail.

First, a proximity sensor refers to a sensor that detects the presence or absence of an object approaching a predetermined detection surface or an object existing in the vicinity by using the force of an electromagnetic field, infrared light, or the like without mechanical contact. The proximity sensor may be disposed at a position at which the proximity sensor may recognize whether the detachable module 170 is attached to the eyeglasses 100 for providing varifocal focus and is coupled with the eyeglasses 100 for providing varifocal focus.

Examples of the proximity sensor include a transmittable photoelectric sensor, a direct reflective photoelectric sensor, a mirror reflective photoelectric sensor, a high frequency oscillation type proximity sensor, a capacitive proximity sensor, a magnetic type proximity sensor, and an infrared proximity sensor. The proximity sensor may be configured to detect proximity of the object based on the change in an electric field according to the proximity of the conductive object (for example, the detachable module).

The ultrasonic sensor may recognize location information of a detection target by using ultrasonic waves. In the meantime, the control unit 180 may calculate a location of a wave generation source through information detected by the optical sensor and the plurality of ultrasonic sensors. The location of the wave generation source may be calculated by using a property that light is much faster than ultrasonic waves, that is, the time when the light reaches the optical sensor is much faster than the time when the ultrasonic wave reaches the ultrasonic sensor. More particularly, the location of the wave generation source may be calculated by using a time difference between a time when the ultrasonic waves reach and a time when light reaches based on the light as a reference signal.

The control unit 180 may recognize a distance between a target to be viewed by the user and the eyeglasses 100 for providing varifocal focus by using at least one of the ultrasonic sensor and the optical sensor included in the sensor unit 160.

The control unit 180 generally controls the generation operation of the eyeglasses 100 for providing varifocal focus in addition to the operation related to the application program stored in the memory unit 120. The control unit 180 may process signals, data, information, and the like input or output through the foregoing constituent elements, or drive the application program stored in the memory unit 120.

The detachable module 170 is the module attachable to and detachable from the eyeglasses 100 for providing varifocal focus, and may include the display module 171 and the bone conduction module 172. The foregoing constituent elements are not essential for implementing the detachable module 170, so that the detachable module 170 described in the present specification may include more or less constituent elements than the constituent elements listed above.

When the detachable module 170 is attached to the eyeglasses 100 for providing varifocal focus, the detachable module 170 may be electrically connected with the eyeglasses 100 for providing varifocal focus. Accordingly, when the detachable module 170 is attached to the eyeglasses 100 for providing varifocal focus, the power supply unit 150 of the eyeglasses 100 for providing varifocal focus may supply power to the display module 171. Further, when the detachable module 170 is attached to the eyeglasses 100 for providing varifocal focus, the power supply unit 150 of the eyeglasses 100 for providing varifocal focus may supply an alternating-current signal to the bone conduction module 172.

That is, the bone conduction module 172 and the display module 171 may receive common power through the eyeglasses 100 for providing varifocal focus in one module form.

According to several exemplary embodiments, when the detachable module 170 is attached to the first frame of the eyeglasses 100 for providing varifocal focus, the detachable module 170 may also receive power from the power supply unit 150 only when a predetermined input (for example, an input pre-set by a specific user) is input through the user input unit 140. In this case, only a specific user is allowed to use the detachable module 170, so that user security may be enhanced.

The display module 171 may display (output) visual information. Herein, the visual information may mean visually recognizable information, such as an images, text, videos, photos, and figures.

According to several exemplary embodiments, when it is recognized that the detachable module 170 is attached to the eyeglasses 100 for providing varifocal focus, the control unit 180 may make information about the characteristic of the eyeglasses and eyesight of the user wearing the eyeglasses be recognized by the memory unit 120 and control a location and a distance at which the visual information is displayed in the display module 171.

According to other several exemplary embodiments, when it is recognized that the detachable module 170 is attached to the eyeglasses 100 for providing varifocal focus, the control unit 180 may make information about eyesight of the user wearing the eyeglasses be recognized by the memory unit 120 and control a predetermined voltage to be provided to the lens (for example, the first lens) related to the location at which the detachable module is mounted. Herein, the predetermined voltage may be a voltage suitable for the user to view visual information, and be pre-stored in the memory unit 120, or an algorithm for calculating a predetermined voltage by using the eyesight of the user wearing the eyeglasses may be pre-stored in the memory unit 120.

According to other several exemplary embodiments, when it is recognized that the detachable module 170 is attached to the eyeglasses 100 for providing varifocal focus and the user input is received through the user input unit 140, the control unit 180 may control the predetermined voltage to be supplied to the lens (for example, the first lens) related to the location at which the detachable module is mounted. The reason is that the user may not use the display unit 171 in the form of a head mounted display type in the state where the detachable module 170 is attached.

The display module 171 may be implemented in the form of a Head Mounted Display (HMD) type. The HMD type refers to a display scheme that is mounted on the head and shows visual information directly in front of the eyes of a user. When the user wears the eyeglasses 100 for providing varifocal focus, the display module 171 may be displayed so as to correspond to at least one of a left eye and a right eye so as to directly provide visual information in front of the eyes of the user.

The display module 171 may project an image to the eyes of the user by using a prism. Further, the prism may be formed to be transparent so that the user is capable of seeing the projected image and the general field of view in front (the range that the user sees through the eyes). Further, the display module 171 may be formed of an optical see-through display panel.

As described above, the image output through the display module 171 may overlap with a general view to be viewed. The eyeglasses 100 for providing varifocal focus may provide Augmented Reality (AR) that superimposes a virtual image on a real image or background and displays the superimposed image as one image by using the characteristic of the display.

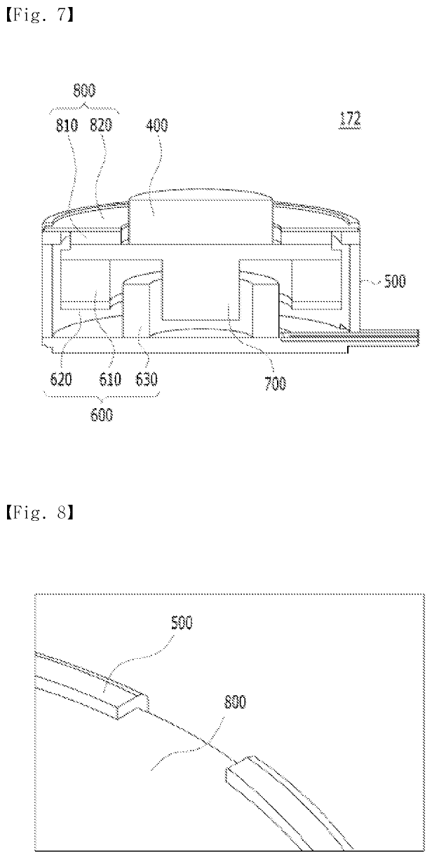

The bone conduction module 172 may output a sound in a bone conduction method under the control of the control unit 180. When the user wears the eyeglasses in the state where the detachable module 170 is attached to the first frame of the eyeglasses 100 for providing varifocal focus, the bone conduction module 172 may be in close contact with a rear portion of the ear in a temporal bone, and vibrate the skull and transmit a sound. However, the present disclosure is not limited thereto, and when the user wears the eyeglasses in the state where the detachable module 170 is attached to the first frame of the eyeglasses 100 for providing varifocal focus, the bone conduction module 172 may also be in close contact with a front portion of the ear in the temporal bone. The bone conduction module 172 will be described in detail with reference to FIGS. 7 to 9 below.

In the meantime, although not illustrated in the drawing, when the detachable module 170 is attached to the eyeglasses 100 for providing varifocal focus, the detachable module 170 may receive data, information, and the like from the eyeglasses 100 for providing varifocal focus. However, the present disclosure is not limited thereto, and the detachable module 170 may include a communication unit, a control unit, and a memory separately from the eyeglasses 100 for providing varifocal focus, and receive only power from the eyeglasses 100 for providing varifocal focus.

According to the exemplary embodiment, the user may remove the detachable module 170 from the eyeglasses 100 for providing varifocal focus and use the eyeglasses 100 for providing varifocal focus only for the purpose of the eyeglasses 100 for providing varifocal focus, and when the detachable module 170 is attached to the eyeglasses 100 for providing varifocal focus, the user may also use the eyeglasses 100 for providing varifocal focus like the HMD device.

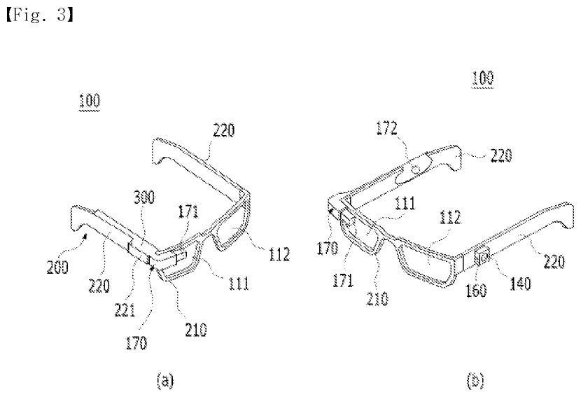

FIG. 3 is a diagram illustrating an example of the glasses providing varifocal focus to which the detachable module is attached according to several exemplary embodiments.

Referring to (a) and (b) of FIG. 3, the eyeglasses 100 for providing varifocal focus is configured to be worn on the head of the body of the user, and to this this, the eyeglasses 100 for providing varifocal focus may include the first frame 200. The first frame 200 may be formed of a flexible material so that the user may easily wear the eyeglasses 100 for providing varifocal focus.

The first frame 200 is supported by the head, and may provide a space in which various components are mounted. For example, a space is formed inside the first frame 200, so that the power supply unit 150 may be embedded in the first frame 200.

As illustrated in (a) and (b) of FIG. 3, the first frame 200 may be formed of a lens part 210 in which the first lens 111 and the second lens 112 are detachably mounted, and a leg part 220 supporting the lens part 210.

Referring to (a) of FIG. 3, the leg part 220 of the first frame 200 may be provided with a coupling unit 221 so that the detachable module 170 is attached to the first frame 200. In (a) of FIG. 3, it is illustrated that the coupling unit 221 is coupled to the leg part 220 corresponding to the right eye, but the present disclosure is not limited thereto, and the leg part 220 may also be coupled to the leg part 220 corresponding to the left eye.

The coupling unit 221 may protrude from one surface of the leg part 220 toward the outside. However, the present disclosure is not limited thereto.

The sensor unit 160 (for example, the proximity sensor) is embedded in the coupling unit 221 toward the front, so that it is possible to recognize whether the detachable module 170 is attached to the coupling unit 221.

In particular, when the control unit 180 recognizes that an object exists within a predetermined distance (for example, 5 mm) for a predetermined time (for example, 10 seconds) or longer through the proximity sensor embedded in the coupling unit 221 toward the front, the control unit 180 may recognize that the detachable module 170 is attached to the coupling unit 221.

In the meantime, referring to (b) of FIG. 3, the user input unit 140 and the sensor unit 160 may be provided in the leg part 220 of the first frame 200.

The sensor unit 160 may measure a distance to an object to be viewed by the user of the eyeglasses 100 for providing varifocal focus. The sensor unit 160 may be provided at one side of the leg part 220 so as to head the front. Herein, the sensor unit 160 may be formed of a laser sensor, an ultrasonic sensor, and the like, but is not limited thereto.

The control unit 180 may adjust a size of a voltage supplied to each of the first lens 111 and the second lens 112 base on the distance to the object to be viewed by the user measured through the sensor unit 160.

The sensor unit 160 may be mounted to one region of the leg part 220 of the first frame 200 and disposed so as to face the user's gaze direction. However, the present disclosure is not limited thereto, and the sensor unit 160 may also be provided in the lens part 210 of the first frame 200 and disposed so as to face the user's gaze direction.

The user input unit 140 may be positioned at one side of the leg part 220 of the first frame 200. Accordingly, the user may easily input the user's input through the user input unit 140. In (b) of FIG. 3, it is illustrated that the user input unit protrudes, but the present disclosure is not limited thereto, and the user input unit 140 may also be located in one portion of the leg part 220 of the first frame 200.

The first lens 111 and the second lens 112 covering the right eye and the left eye may be mounted to the lens part 210 of the first frame 200. The first lens 111 and the second lens 112 may also be attachable to and detachable from the lens part 210.

Referring to (a) of FIG. 3, when the detachable module 170 is attached to the first frame 200, the display module 171 may be located in front of the first lens 111. However, the present disclosure is not limited thereto, and when the detachable module 170 is attached to the first frame 200, the display module 171 may be located in front of the second lens 112.

The display module 171 may receive power from the power supply unit 150 according to the attachment of the detachable module 170 to the first frame 200 to be driven.

In the meantime, the detachable module 170 may include a second frame 300 extending from an upper surface of the leg part 220 of the first frame 200 to the rear portion of the ear of the user along the leg part 220 when the user wears the eyeglasses 100 for providing varifocal focus in the state where the detachable module 170 is mounted to the first frame 200. However, the present disclosure is not limited thereto, and the detachable module 170 may include a third frame (not illustrated) extending from the upper surface of the leg part 220 of the first frame 200 to the front portion of the ear of the user along the leg part 220 when the user wears the eyeglasses 100 for providing varifocal focus in the state where the detachable module 170 is mounted to the first frame 200.

The second frame 300 (or the third frame) may be made of plastic of a polypropylene material. However, the present disclosure is not limited thereto.

Referring to (b) of FIG. 3, the second frame 300 may extend from the rear portion of the ear of the temporal bone of the user toward an inner side of the leg part 220 of the first frame 200. Further, the bone conduction module 172 may be located on one region of the second frame 300 extending toward the inner side of the leg part 220 of the first frame 200. That is, the bone conduction module 172 may be in close contact with the rear portion of the ear of the temporal bone in the case where the user wears the eyeglasses 100 for providing varifocal focus in the state where the detachable module 170 is attached to the first frame 200.

In particular, the second frame 300 may include an insertion hole to which the bone conduction module 172 is inserted in a first region corresponding to the rear portion of the ear of the temporal bone of the user in the case where the user wears the eyeglasses 100 for providing varifocal focus in the state where the detachable module 170 is attached to the first frame 200. The bone conduction module 172 may be inserted into the insertion hole.

According to several exemplary embodiments, the third frame may extend to the inner side of the leg part 220 of the first frame 200 in the front portion of the ear of the temporal bone of the user. Further, the bone conduction module 172 may be located on one region of the third frame extending to the inner side of the leg part 220 of the first frame 200. That is, the bone conduction module 172 may be in close contact with the front portion of the ear of the temporal bone in the case where the user wears the eyeglasses 100 for providing varifocal focus in the state where the detachable module 170 is attached to the first frame 200. In particular, the third frame may include an insertion hole into which the bone conduction module 172 is inserted in the second region corresponding to the front portion of the ear of the temporal bone of the user in the case where the user wears the eyeglasses 100 for providing varifocal focus in the state where the detachable module 170 is attached to the first frame 200. The bone conduction module 172 may be inserted into the insertion hole.

An upper surface (for example, a vibration plate 400 of FIG. 7) of the bone conduction module 172 may be exposed through an upper surface of an opening formed by the insertion hole. Further, the bone conduction module 172 may be inserted into the insertion hole so as to be capable of vibrating.

In the meantime, according to several exemplary embodiments, the second frame 300 or the third frame may also further include a sliding member. In this case, the user may adjust a length of the second frame 300 or the third frame to change the location at which the bone conduction module 172 is disposed. Since a size of the head is different for each user, the user is capable of adjusting the length of the second frame 300 or the third frame to the length suitable to the user, thereby providing convenience to the user.

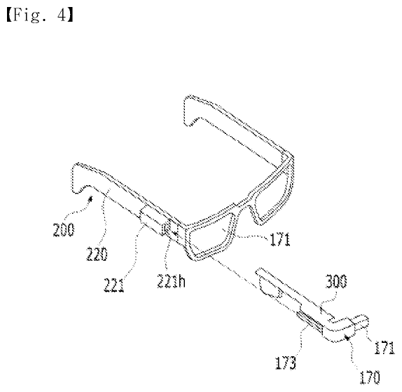

FIG. 4 is a diagram for describing an example of a method of attaching the detachable module to the glasses providing varifocal focus according to several exemplary embodiments. In relation to FIG. 4, contents overlapping the content described with reference to FIG. 3 will not be described again, and the difference will be mainly described.

Referring to FIG. 4, the detachable module 170 may include a power receiving unit 173 receiving power from the power supply unit 150. Further, the coupling unit 221 provided in the leg part 220 of the first frame 200 may include a coupling hole 221h into which the power receiving unit 173 may be inserted.

For example, the coupling hole 221h may be a male terminal of a 3.5 pi terminal, and the power receiving unit 173 may be a female terminal of a 3.5 pi terminal. In this case, when the coupling hole 221h and the power receiving unit 173 are completely coupled, the power receiving unit 173 may no longer proceed into the coupling hole 221h with a “click” sound.

For another example, the power receiving unit 173 may be a Universal Serial Bus (USB) terminal, and the coupling hole 221h may have a structure into which the USB terminal is inserted. In this case, when the coupling hole 221h and the power receiving unit 173 are completely coupled, the power receiving unit 173 may no longer proceed into the coupling hole 221h with a “click” sound.

The foregoing examples are merely illustrative, and the exemplary embodiments of the present disclosure are not limited to the foregoing examples.

Since the power receiving unit 173 supports the detachable module 170 with predetermined pressure in the state of being inserted into the coupling hole 221h, it is desirable that the power receiving unit 173 has a degree that may withstand certain force (for example, force corresponding to weight of the detachable module 170).

When the power receiving unit 173 is inserted into the coupling hole 221h, the power receiving unit 173 may be hidden by the coupling unit 221 and not be viewed from the outside.

An inner shape of the coupling hole 221h may correspond to a shape of the power receiving unit 173. Accordingly, the power receiving unit 173 may be inserted into the coupling hole 221h, and the power receiving unit 173 may be coupled with the coupling hole 221h by fitting coupling, forcibly fitting coupling, and the like.

As described above, when the inner shape of the coupling hole 221h corresponds to the shape of the power receiving unit 173, the detachable module 170 may be attached to the first frame 200 unless the user separates the detachable module 170 in the state where the power receiving unit 173 is inserted into the coupling hole 221h.

In the meantime, when the power receiving unit 173 is inserted into the coupling hole 221h, the power supply unit 150 may be electrically connected with the detachable module 170. Accordingly, the display module 171 included in the detachable module 170 may receive power from the power supply unit 150, and the bone conduction module 172 included in the detachable module 170 may receive an alternating current from the power supply unit 150.

The opening of the coupling hole 221h may face the front. Accordingly, when the detachable module 170 is attached to the coupling unit 221, the display module 171 included in the detachable module 170 may be located in front of the first lens 111.

The second frame 300 of the detachable module 170 may extend from an upper surface of the leg part 220 of the first frame 200 to the rear portion of the ear of the user along the leg part 220. Further, the second frame 300 may extend from the rear portion of the ear of the temporal bone of the user toward the inner side of the leg part 220. Accordingly, the second frame 300 is supported through the leg part 220 of the first frame 200, so that the force applied to the power receiving unit 173 inserted into the coupling hole 221h may be distributed to the leg part 220 of the first frame 200. In this case, it is possible to prevent the power receiving unit 173 from being damaged.

According to several exemplary embodiments, the third frame of the detachable module 170 may extend from the upper surface of the leg part 220 of the first frame 200 only to the front portion of the ear of the user along the leg part 220. Further, the third frame may also extend from the front portion of the ear of the temporal bone of the user toward the inner side of the leg part 220.

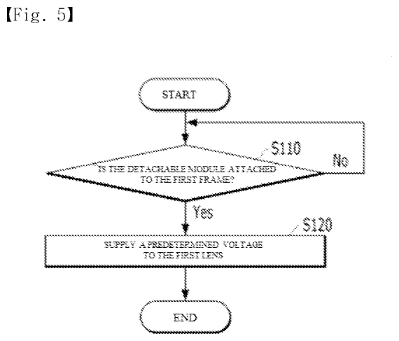

FIG. 5 is a flowchart illustrating an example of a method of supplying a predetermined voltage to the first lens in the case where the detachable module is attached to the first frame according to several exemplary embodiments of the present disclosure. In relation to FIG. 5, contents overlapping the content described with reference to FIGS. 1 to 4 will not be described again, and the difference will be mainly described.

Referring to FIG. 5, the control unit 180 may recognize whether the detachable module is attached to the first frame 200 through the sensor unit 160 (S110).

In particular, the sensor unit 160 (for example, the proximity sensor) may be disposed at a location at which whether the detachable module 170 is attached to the eyeglasses 100 for providing varifocal focus and is coupled with the eyeglasses 100 for providing varifocal focus is recognizable. That is, the sensor unit 160 may be embedded in the coupling unit 221 toward the front. Further, when the control unit 180 recognizes that a specific object exists in the front within a predetermined distance (for example, 5 mm) for a predetermined time (for example, 10 seconds) or longer through the proximity sensor embedded in the coupling part 221 toward the front, the control unit 180 may recognize that the detachable module 170 is attached to the eyeglasses 100 for providing varifocal focus.

When the control unit 180 recognizes that the detachable module 170 is not attached to the first frame 200 (S110, NO), the control unit 180 may periodically check whether the detachable module 170 is attached to the first frame 200.

In the meantime, when the control unit 180 recognizes that the detachable module 170 is attached to the first frame (S110, YES), the control unit 180 may control a predetermined voltage to be supplied to the first lens 111 (S120). Herein, the predetermined voltage may be a voltage suitable for the user to view visual information displayed in the display module 171 and be pre-stored in the memory unit 120, or an algorithm for calculating a predetermined voltage by using the eyesight of the user wearing the eyeglasses may be pre-stored in the memory unit 120.

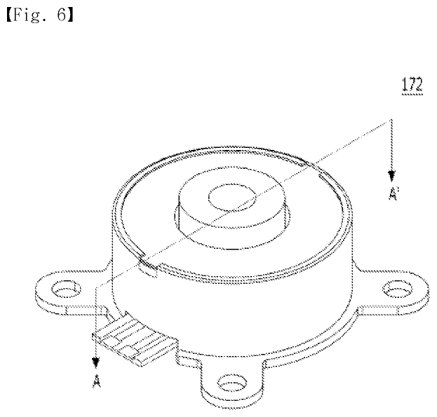

FIG. 6 is a diagram illustrating an example of an exterior appearance of a bone conduction module included in the detachable module according to several exemplary embodiments of the present disclosure. FIG. 7 is a cross-sectional view of the bone conduction module taken along line A-A′ of FIG. 6. FIG. 8 is an enlarged view of one region of an upper surface of the bone conduction module included in the detachable module according to several exemplary embodiments of the present disclosure.

An exterior appearance of the bone conduction module 172 according to several exemplary embodiments of the present disclosure may have a shape illustrated in FIG. 6. However, the present disclosure is not limited thereto, and the bone conduction module 172 may have various shapes.

In the meantime, referring to FIG. 7, the bone conduction module 172 may include the vibration plate 400, a housing 500, a magnetic circuit 600, a yoke unit 700, and an elastic unit 800.

The housing 500 includes an opened upper surface and lower surface and closed lateral surfaces, so that the housing 500 may have a space therein. For example, the housing 500 may have a cylindrical form including an opened upper surface and lower surface. Further, the housing 500 may have a quadrangular form including an opened upper surface and lower surface, but is not limited thereto.

The housing 500 may include at least one constituent element of the bone conduction module 172 in the internal space. For example, a coil 630, the magnetic circuit 600, the yoke unit 700, the elastic unit 800, or a combination thereof may be included in the internal space of the housing 500, but the present disclosure is not limited thereto.

The housing 500 may be molded with various members. The housing 500 may be molded with a metal member (for example, iron, nickel, and copper) and may be molded with reinforced plastic, but is not limited thereto.

The magnetic circuit 600 may generate vibration. The magnetic circuit 600 may include a magnet 610 and a top plate 620. Herein, the magnet 610 may be formed of a material having magnetic force, and may vibrate according to a change in a surrounding magnetic field. Further, the top plate 620 may concentrate magnetic force of the magnet 610.

The coil 630 may receive the alternating-current signal from the power supply unit 150 according to the attachment of the detachable module 170 to the first frame 200.

The magnetic circuit 600 may be provided at a predetermined interval with the coil 630. When the alternating-current signal is applied to the coil 630, the magnet 610 may vibrate according to a direction and intensity and a size of a frequency of the alternating-current signal applied to the coil 630. That is, the magnet 610 may serve as a vibrator that vibrates according to the alternating-current signal applied to the coil 630.

This is due to Fleming's left-hand rule that a conductor placed in a magnetic field receives force in a predetermined direction, and the theory related to the principle is a known technology, so that a detailed description will be omitted.

In the related art, a vibration motor using a brush and a commutator is frequently used, but has a problem in excessive noise and miniaturization. The bone conduction module 172 of the present disclosure includes the coil 630 and the magnetic circuit 600 in order to generate vibration, and the vibration generated by the magnetic circuit 600 may be transmitted to the yoke unit 700 that is in contact with an upper surface of the magnetic circuit 600.

The yoke unit 700 may be provided so as to be in contact with the upper surface of the magnetic circuit 600. Herein, the contact of the yoke unit 700 with the magnetic circuit 600 may mean that the yoke unit 700 is provided so that the vibration generated in the magnetic circuit 600 is directly transmitted to the yoke unit 700 without providing a separate vibration transmitter between the yoke unit 700 and the magnetic circuit 600. That is, the vibration generated in the magnetic circuit 600 may be directly transmitted to the yoke unit 700 by sequentially stacking the yoke unit 700 on the upper surface of the magnetic circuit 600 or integrally manufacturing the magnetic circuit 600 and the yoke unit 700 at the time of the manufacturing.

The elastic unit 800 may include a plurality of constituent elements. For example, the elastic unit 800 may include an elastic body 810 and an elastic suspension 820.

The elastic unit 800 may be formed in various methods. For example, the elastic unit 800 may be formed by coupling the separately formed elastic body 810 and elastic suspension 820. For another example, the elastic body 810 and the elastic suspension 820 may be integrally formed by a casting method using a metal member, but the present disclosure is not limited thereto.

The elastic suspension 820 may be in contact with at least a part of an upper surface of the elastic body 810. Further, the elastic suspension 820 may be attached to at least a part of the upper surface of the elastic body 810 to be coupled with the elastic body 810.

The elastic suspension 820 is seated on the upper surface of the elastic body 810, thereby protecting the elastic body 810 and increasing excitation force of the elastic unit 800, but the present disclosure is not limited thereto, and may exhibit various effects.

The elastic unit 800 may include an opening at a center thereof. The elastic unit 800 and the opening may be integrally molded so that the vibration plate 400 is exposed to the outside through the opening. The vibration plate 400 is exposed to the outside, so that the vibration plate 400 may be in direct contact with the body and the like.

In the meantime, the vibration plate 400 may be directly attached to the yoke unit 700 without a rivet to be coupled with the yoke unit 700. However, the present disclosure is not limited thereto, and the yoke unit 700 may also be coupled with the vibration plate 400 through a rivet.

Referring to FIG. 8, the bone conduction module 172 may include the housing 500 and the elastic unit 800, and the housing 500 and the elastic unit 800 may be coupled in various methods.

For example, the elastic unit 800 may be attached to the inner surface of the housing 500 to be coupled with the housing 500. Further, the elastic unit 800 may be coupled with the housing 500 by curling of the housing 500. That is, at least a part of the upper portion of the housing 500 is curled in the direction of the elastic unit 800, so that the elastic unit 800 may be seated on the upper surface of the housing 500.

The curling means bending at a predetermined angle (for example, 90°), and the predetermined angle may be determined in various methods.

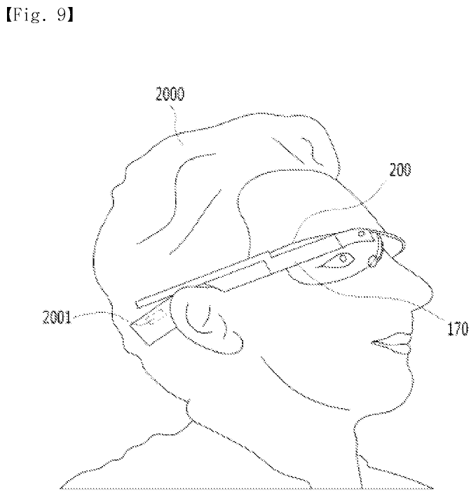

FIG. 9 is a diagram illustrating an example of the case where a user wears the glasses providing varifocal focus to which the detachable module is attached according to several exemplary embodiments.

Referring to FIG. 9, a user 2000 may wear the eyeglasses 100 for providing varifocal focus to which the detachable module 170 is attached. In this case, the bone conduction module included in the detachable module may be in close contact with a rear portion 2001 of the ear of the temporal bone of the user 2000.

However, the present disclosure is not limited thereto, and when the user 2000 wears the eyeglasses 100 for providing varifocal focus to which the detachable module 170 is attached, the bone conduction module included in the detachable module may be in close contact with a front portion of the ear of the temporal bone of the user 2000.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

As described above, the relevant contents are described in the best mode for implementing the present invention.

The present disclosure relates to eyeglasses for providing varifocal focus, and particularly, provides various functions to eyeglasses providing varifocal focus in which a bone conduction module and a display module are attached/detached in a form of one module.

1. Eyeglasses, comprising:
a power supply unit;
one or more lens receiving a voltage from the power supply unit, and providing varifocal focus;
a first frame coupled with the one or more lens, and having a shape to be worn by a user; and
a detachable module being detachable to the first frame,
wherein the first frame comprises:
a coupling unit being located at one side of the first frame and comprising a coupling hole,
wherein the detachable module comprises:
a power receiving unit having a shape that corresponds to a shaped of the coupling hold in order to couple to the coupling hole, and receiving power from the power supply unit via the coupling hole; and
a sub module driven by receiving power from the power supply unit, as the power receiving unit is coupled to the coupling hole.

2-4. (canceled)

5. The eyeglasses according to claim 1, wherein the detachable module further comprises a second frame extending from an upper surface of a leg unit of the first frame to a rear portion of the user's ear along the leg unit, and extending from a rear portion of the ear in the user's temporal bone toward an inner side of the leg unit if the user wears the eyeglasses while the detachable module is attached to the first frame.

6. The eyeglasses according to claim 5, wherein the second frame has an insertion hole, into which the sub module is inserted, in a first region corresponding to the rear portion of the ear in the user's temporal bone if the user wears the eyeglasses while the detachable module is attached to the first frame.

7. The eyeglasses according to claim 1, wherein the sub module is in close contact with a rear portion of the ear in the user's temporal bone if the user wears the eyeglasses while the detachable module is attached to the first frame.

8. The eyeglasses to claim 1, wherein the detachable module comprises a third frame extending from an upper surface of a leg unit of the first frame to a front portion of the user's ear along the leg unit, and extending from a front portion of the ear in the user's temporal bone toward an inner side of the leg unit if the user wears the eyeglasses while the detachable module is attached to the first frame.

9. The eyeglasses according to claim 8, wherein the second frame has an insertion hole, into which the sub module is inserted, in a second region corresponding to the front portion of the ear in the user's temporal bone if the user wears the eyeglasses while the detachable module is attached to the first frame.

10. The eyeglasses according to claim 1, wherein the sub module is in close contact with a front portion of the ear in the user's temporal bone if the user wears the eyeglasses while the detachable module is attached to the first frame.

11. The eyeglasses according to claim 1, further comprising:
a sensor unit recognizing whether the detachable module is attached to the first frame; and
a control unit controlling the one or more lens to be supplied with a pre-determined voltage, if the detachable module is recognized, via the sensor unit, to be attached to the first frame.

12. The eyeglasses according to claim 11, further comprising:
a user input unit receiving a user input for changing an operation mode of the eyeglasses,
wherein the control unit controls the one or more lens to be supplied with the pre-determined voltage as the detachable module is recognized, via the sensor unit, to be attached to the first frame and the user input is received via the user input unit.

13. The eyeglasses according to claim 1,
wherein the bone conduction module comprises:
a housing having a space formed therein by opening the upper and lower surfaces and closing sides;
a coil located inside the housing, and receiving the AC signal from the power supply unit as the detachable module is attached to the first frame;
a magnetic circuit generating vibration according to a change in a magnetic field provided by the coil;
a yoke unit in contact with an upper surface of the magnetic circuit;
an elastic unit vibrating in contact with at least a portion of an upper surface of the yoke unit; and
a vibration plate in contact with at least a portion of the upper surface of the yoke unit, and outputting the vibration outside according to the vibration of the yoke unit.

14. The eyeglasses according to claim 13, wherein at least a portion of an upper portion of the housing is bent so that the elastic unit is coupled with the housing.

15. The eyeglasses according to claim 1,
wherein the sub module comprises a display module,
wherein the display module is positioned in front of the one or more lens, as the power receiving unit is coupled to the coupling hole.

16. A display device, comprising:
a power supply unit;
one or more lens receiving a voltage from the power supply unit, and providing varifocal focus;
a first frame coupled with the one or more lens, and having a shape to be worn by a user; and
a detachable module being detachable to the first frame,
wherein the first frame comprises:
a coupling unit being located at one side of the first frame, and comprising a coupling hole,
wherein the detachable module comprises:
a power receiving unit having a shape that corresponds to a shape of the coupling hole in order to couple to the coupling hole, and receiving power from the power supply unit via the coupling hole; and
a sub module driven by receiving power from the power supply unit, as the power receiving unit is coupled to the coupling hole.
